(19) United States
(12) Patent Application Publication
(10) Pub. No.: US 2015/0193858 A1
(43) Pub. Date: Jul. 9, 2015

(54) POST TRANSACTION ORDER MODIFICATION SYSTEM

(71) Applicant: Modest, Inc., Chicago, IL (US)

(72) Inventors: Harper Reed, Chicago, IL (US); Dylan Richard, Chicago, IL (US); Gauri Sharma, Chicago, IL (US)

(21) Appl. No.: 14/592,260

(22) Filed: Jan. 8, 2015

Related U.S. Application Data
(60) Provisional application No. 61/925,091, filed on Jan. 8, 2014.
(60) Provisional application No. 62/066,064, filed on Oct. 20, 2014.

(51) Int. Cl. G06Q 30/06

(52) U.S. Cl. CPC G06Q 30/0633

(57) ABSTRACT

A system and application for modifying an electronic transaction with a seller after the transaction has been completed. An electronic receipt or confirmation listing the information associated with a recently completed electronic transaction is provided on a user's device, including a time display showing how much time remains to modify or cancel the completed transaction and an unbuy selector. Upon user selection of the unbuy selector during the displayed time window, the completed electronic transaction is immediately cancelled. Rebuy and continue shopping options are provided with the cancellation receipt. Product, shipping address, shipping method, payment method, gift and coupon options are also modifiable after an electronic order transaction is completed. Methods and machine-readable medium for post transaction order modification are also provided.

### CROSS-REFERENCE TO RELATED APPLICATIONS

This application claims the benefit of U.S. Provisional Patent Application No. 61/925,091, filed Jan. 8, 2014, and U.S. Provisional Patent Application No. 62/066,064, filed Oct. 20, 2014, both of which are expressly incorporated herein by reference and made a part hereof.

### TECHNICAL FIELD

The present disclosure generally relates to modifying an order after the transaction is complete, and, in particular, to modifying or cancelling an electronic or online order after it has been placed and before the order is fulfilled.

### BACKGROUND

Various electronic ordering systems include online ordering systems and ordering systems utilizing mobile applications or an application program interface. Electronic ordering systems typically provide limited or no options for a user to easily change an aspect of the user's order once the electronic transaction has been completed. The user typically has to cancel the electronic transaction and start over with a new transaction, or the user may have to contact customer service. For example, after a user completes an electronic purchase transaction for a shirt and receives an electronic receipt/confirmation of the order, the user may realize that the size is incorrect and want to change it. Though the shirt may not have been shipped yet, the user will likely have to call customer service to have the size changed in this example. Other elements of an electronic order are also not typically easily changed after the electronic transaction is completed by the user. For example, changing a shipping address, changing a payment method, changing a shipping method, changing a gift status and adding additional services (e.g., gift wrapping, monogramming) all typically require the help of customer assistance or require the user to cancel the entire order and redo the order with the new information.

Accordingly, it is desirable to provide an electronic order transaction system that allows the user to modify some or all aspects of the electronic order after the transaction has been completed and before the order is processed for shipping or shipped.

### SUMMARY

According to one embodiment, the disclosed subject technology relates to a system for providing a post transaction order modification. The system includes one or more processors, one or more storage memories, a display and a post transaction order module comprising instructions for causing the one or more processors to execute a method for providing post transaction order modification of an electronic transaction. The method includes providing, on the display, details of a recently completed online purchase transaction. In one embodiment, the details comprise a listing of one or more products purchased, a shipping address, a shipping method, a payment method and a receipt. The method also includes providing, on the display, a time display showing how much time remains to modify or cancel the completed online purchase transaction. The method further includes providing, on the display, an unbuy selector associated with recently completed online purchase transaction. The method also includes providing, by the one or more processors, for an immediate cancellation of the completed online purchase transaction when the unbuy selector is selected while there is still time remaining in the time display.

The disclosed technology further relates to a non-transitory machine-readable storage medium comprising machine readable instructions for causing a processor to execute a method for providing post transaction order modification of an electronic transaction. The method includes providing, on the display, details of a recently completed online purchase transaction. In one embodiment, the details comprise a listing of one or more products purchased, a shipping address, a shipping method, a payment method and a receipt. The method also includes providing, on the display, a time display showing how much time remains to modify or cancel the completed online purchase transaction. The method further includes providing, on the display, an unbuy selector associated with recently completed online purchase transaction. The method also includes providing, by the one or more processors, for an immediate cancellation of the completed online purchase transaction when the unbuy selector is selected while there is still time remaining in the time display.

The disclosed technology further relates to a computer implemented method for post transaction order modification of an electronic transaction. The method includes providing, on the display, details of a recently completed online purchase transaction. In one embodiment, the details comprise a listing of one or more products purchased, a shipping address, a shipping method, a payment method and a receipt. The method also includes providing, on the display, a time display showing how much time remains to modify or cancel the completed online purchase transaction. The method further includes providing, on the display, an unbuy selector associated with recently completed online purchase transaction. The method also includes providing, by the one or more processors, for an immediate cancellation of the completed online purchase transaction when the unbuy selector is selected while there is still time remaining in the time display.

### BRIEF DESCRIPTION OF THE DRAWINGS

To understand the present disclosure, it will now be described by way of example, with reference to the accompanying drawings in which embodiments of the disclosures are illustrated and, together with the descriptions below, serve to explain the principles of the disclosure. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

FIG. 1 is a system diagram of an e-commerce system constructed in accordance with this disclosure.

FIG. 2a is a table illustrating a database record corresponding to a shop.

FIG. 2b is a table illustrating a database record for a catalog item.

FIG. 3 is a flowchart illustrating a process by which a new shopper's information can be gathered.

FIG. 4 is a flowchart illustrating a process by which an order can be placed using the disclosed e-commerce system.

FIG. 5a is a flowchart illustrating a process by which an order can be modified by a shopper.

FIG. 5b is a flowchart illustrating a process by which a return can be processed.

FIG. 6 is a flowchart illustrating a process by which an order can be fulfilled.

FIG. 7 is a flowchart illustrating a process by which items from one shop can be presented to appropriate shoppers of a non-competitive shop.

FIG. 8 is a flowchart illustrating a process by which items can be automatically reordered.

FIG. 9 is a flowchart illustrating a process by which reorders can be generated by the disclosed e-commerce system.

FIG. 10a is a perspective view of a tote bag constructed in accordance with the disclosed e-commerce system.

FIG. 10b is a simplified schematic diagram of a circuit embedded within the tote bag of FIG. 10a to automatically make retail purchases.

FIG. 11a is a side view of a shopping cart constructed in accordance with the disclosed e-commerce system.

FIG. 11b is a simplified schematic diagram of a circuit embedded within the shopping cart of FIG. 11a to automatically make retail purchases.

FIG. 12 is a display illustrating a view that a shopper can receive on first starting a smart phone shopping application.

FIG. 13 is a display illustrating a view that a shopper can receive while entering a search term.

FIG. 14 illustrates an example feature of a post transaction order modification system.

FIG. 15 illustrates another example feature of a post transaction order modification system.

FIG. 16 illustrates another example feature of a post transaction order modification system.

FIG. 17 illustrates another example feature of a post transaction order modification system.

FIG. 18 illustrates another example feature of a post transaction order modification system.

FIG. 19 illustrates another example feature of a post transaction order modification system.

FIG. 20 illustrates another example feature of a post transaction order modification system.

FIG. 21 illustrates another example feature of a post transaction order modification system.

FIG. 22 illustrates another example feature of a post transaction order modification system.

FIG. 23 illustrates another example feature of a post transaction order modification system.

FIG. 24 illustrates another example feature of a post transaction order modification system.

FIG. 25 is a block diagram illustrating an example client and server using the post transaction order modification system of FIGS. 14-24.

FIG. 26 is a block diagram illustrating an example post transaction order modification application in a system.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. Thus, in the following detailed description, numerous specific details are set forth to provide a full understanding of the subject technology. It will be apparent, however, that different aspects of the subject technology may be practiced without some of these specific details. In other instances, well-known structures and techniques have not been shown in detail so as not to obscure the disclosure.

Turning to the Figures and to FIG. 1 in particular, a new e-commerce system is disclosed. A shop server 102 accepts catalog information corresponding to a plurality of shops. For example, the shop server 102 may accept catalogs from a variety of retailers, such as, for example, a sunglass shop, a ladies business clothing store, a high fashion shop, a low price fashion shop, a denim clothing shop, an outdoor clothing store, a footwear store, a plus sized ladies clothing shop, an Asian gift store, a confectionary, a bath store, a home goods store, a jewelry store, an adult toy store, an electronics store, a cell phone store, a music store, an audio-visual store, a children's clothing store, a children's toy store, a lingerie shop, and other types of shop. The shop server 102 creates a structured set of electronic catalogs corresponding to the different shops, and stores those catalogs in the database 108.

A shopper information server 114 gathers information regarding shoppers 151, and creates records in the database 108 corresponding to each shopper. The process by which information is gathered from shoppers is explored in more detail later in this disclosure.

In one embodiment, a catalog server 110 presents catalogs of items from the database 108 to shoppers 151. Similarly, a transaction server 112 allows shoppers 151 to place orders with shops and send messages to shop administrators to fulfill those orders.

It should be noted that shoppers 151 can use a variety of means to transact with the disclosed e-commerce system. For example, shopper 151 a utilizes a smart phone, while shopper 151b utilizes a standard computer and shopper 151c utilizes a tablet computer. Finally, shopper 151d utilizes a wearable computer system. The type of computer system used to transact with the disclosed e-commerce system is not a limitation of the invention.

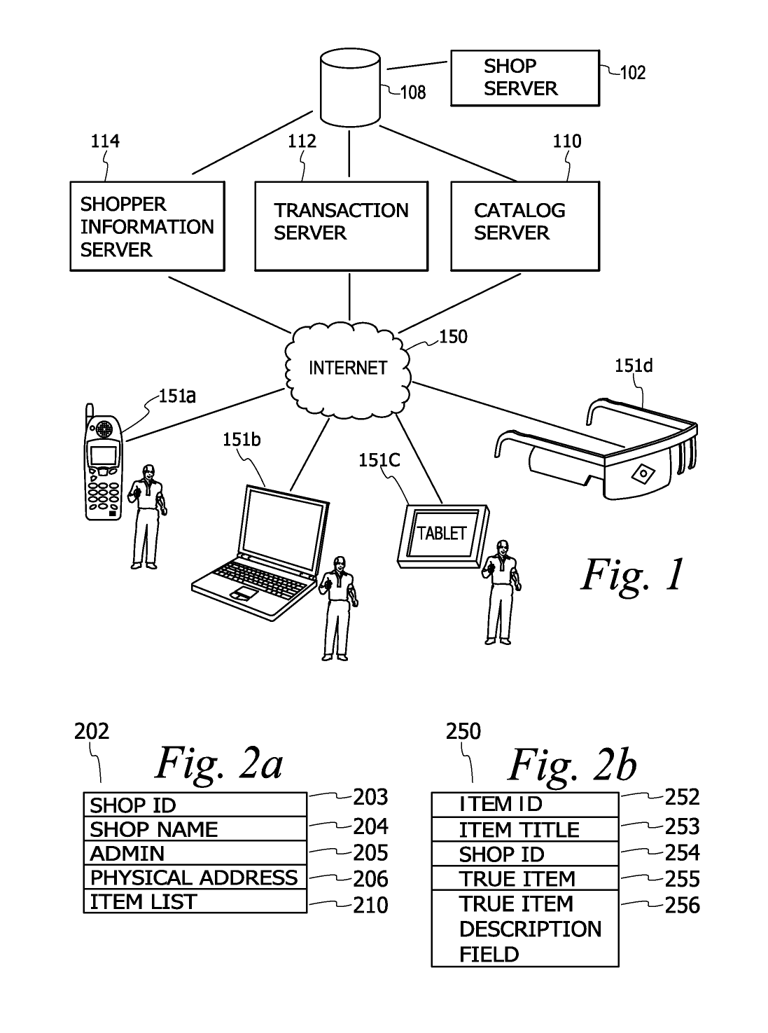

In one embodiment, each electronic catalog comprises a plurality of database records. FIG. 2a depicts a shop record 202 constructed in accordance with this example. It comprises a shop identifier 203, which is unique to shops and used to quickly reference the shop record 202 from another database record. It also comprises a shop name 204, an administrator identifier 205, and a physical address 206. The administrator identifier 205 identifies an administrator record (not depicted) that is used to store access and contact information for one or more shop administrators. In addition, the shop record 202 comprises an item list 210 that references catalog items, as described below.

FIG. 2b depicts a catalog item record 250 constructed in accordance with this example. The catalog item record 250 comprises an item identifier 252, which is unique to items in the database 108 and is used to quickly reference the catalog item record 252 from other records in the database. The catalog item record 250 further comprises an item title 253, a shop identifier (corresponding to the shop which the item belongs to), a true item identifier 255, and a list of true item description fields 256.

A true item identifier 255 corresponds to a generic item type. For example, a true item identifier 255 can identify a set of men's running shoes, a pair of sun glasses, or an audio player. The list of true item description fields 256 comprises a collection of fields that vary based on the generic item type. For example, for a set of men's running shoes, the true item description fields 256 could comprise: a) the primary color; b) the secondary color; c) the shoe size; and d) the type of running shoe (i.e., road, trail, etc.). Other item types would have other item description fields.

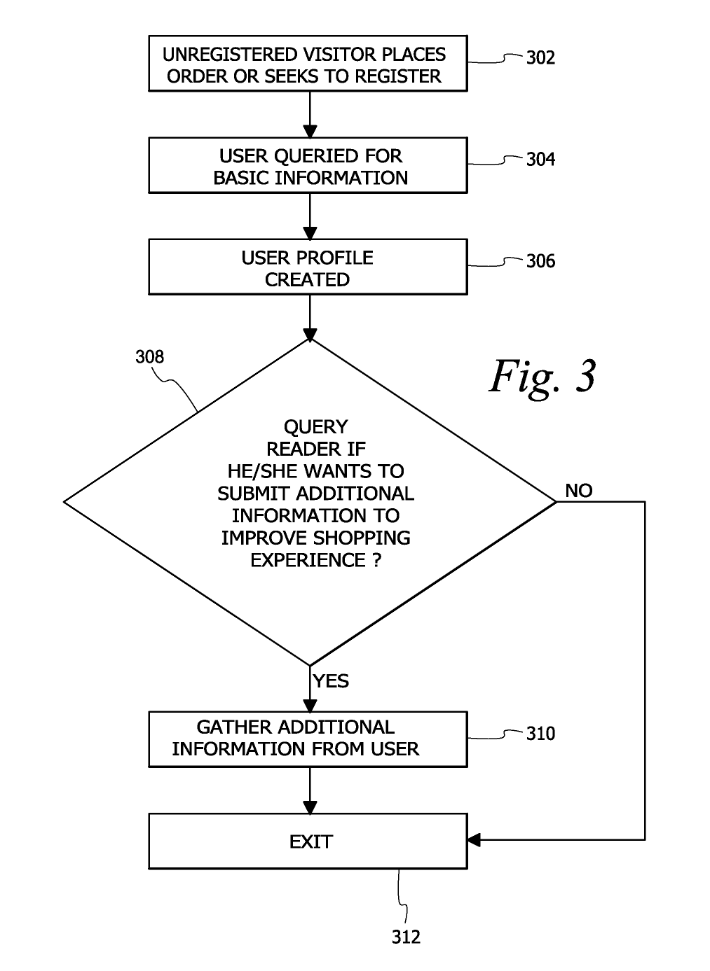

Turning to FIG. 3, a flowchart describing one process by which information from a shopper can be gathered is described. In step 302, an unregistered visitor either seeks to register or attempts to place an order, thereby initiating the information gathering process. In step 304, the user is queried for basic information; i.e.; the user's name, address, email address, mobile phone number, communications preferences, billing information, and billing preferences. With regards to communications preferences, a user can select, for example, to receive order confirmations by email, text message, or robo-call. With regards to billing preferences, a user can select to charge one credit card for certain types of expenses, such as clothing, and another credit card for other expenses, such as office supplies. Other payment forms, such as an online wallet, bit coin address, or gift card can also be entered. Moreover, the user can setup rules that allow for “lowest cost routing” of payment. For example, assuming that a user has three credit cards—one that provides better rates for transactions in excess of $100, one that provides better rates for purchases of electronics goods, and one that is designated as purchases made on behalf of the customer's employer.

In one embodiment, a profile for the user is created in step 306. In step 308, the shopper is queried regarding as to whether s/he wants to submit additional information to improve her shopping experience. If the user prefers to not submit additional information, execution transitions to step 312, where the process is exited. However, if the user agrees to submit additional information, it is gathered in step 310 using any of the profile building techniques well known in the art.

One method by which additional information about a customer's information and preferences can be gathered is through a user's mobile device. Mobile devices, such as smartphones, tend to be used by a single person, and accordingly, tend to have reliable information about that person and that person's preferences. Accordingly, in one embodiment of the disclosed e-commerce system, an application running on a mobile device can gather information regarding the customer, such as the customer's address, phone number, and potentially payment means, such as credit cards, online wallets, etc. Further information regarding a customer's preferences can be gathered through interfaces to other applications, as well as through interfaces through social networks and other online identity sources. For example, from a user's social network, a customer's music and movie likes and dislikes can be extracted, as well as, in many cases, the brands that a user likes. From these preferences, similar brands and preferences can be extrapolated and presented to the user.

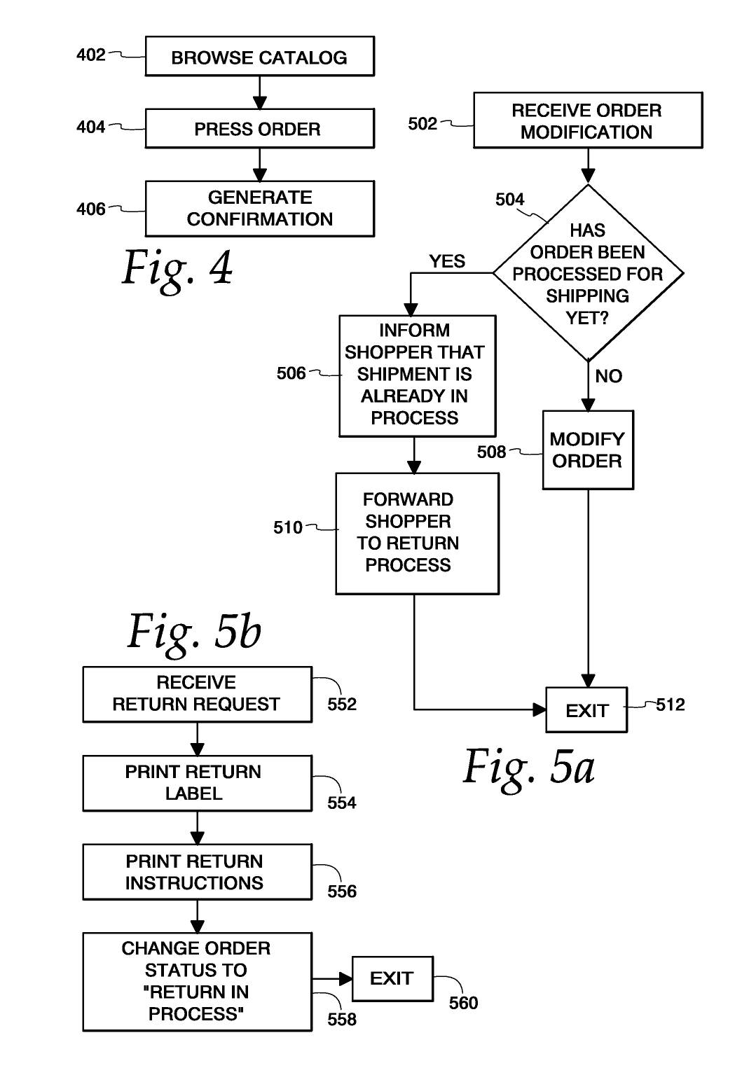

FIG. 4 is a flowchart illustrating one process by which an order can be placed by a shopper. The disclosed multi-tenant e-commerce service does not use a “shopping cart.” Instead, a shopper simply selects “buy” or an equivalent device, which immediately places the order. A confirmation is sent to the user by the user's preferred communication means, allowing the user to modify or cancel the order.

In one embodiment, in step 402, a shopper browses a catalog, or catalogs, until she/he finds a desired item. The shopper then presses “order” or an equivalent device in step 404. A confirmation is sent to the user by the user's preferred communications means in step 406.

In addition, the disclosed e-commerce system supports group ordering. For example, as opposed to pressing “order,” a customer could make an entry that initiates a group order, such as by pressing an “initiate group order” button. The customer could then be presented with a screen that allows the customer to input a list of contacts for other persons who will be participating in the group ordering and an invoice for the amount due from the initiating customer. The amount due from the initiating customer could be an amount set by the initiator, or, alternatively, could be the amount of the item divided by the number of purchasers. The system would then generate messages, such as e-mails or text messages, to the list of contacts specified by the initiating customer. Each message contains a description of the item ordered, such as the catalog listing, a listing of the other persons in the group and their contact information, a listing of which other group members have agreed to the order, an indication of a recommended contribution amount, and a button or other means that allows the user to participate in the group order with a single operation (such as clicking the button). While the recommended contribution amount could be automatically determined or set by the initiator, each contributor could also input a separate amount indicating what they are willing to contribute to the group purchase.

FIG. 5a is a flowchart illustrating one process by which a shopper can modify a placed order. Generally, a shopper will receive an order confirmation via their preferred communications method. The order confirmation will contain a way for the user to modify or cancel their order. For example, an email could contain two HTML links; one to immediately cancel the order, and another to modify the order. If the user has chosen to modify or cancel the order, the process outlined below allows the modification.

In step 502, a request to modify an order is received. In step 504, a check is made to determine whether the order has been processed for shipping. If it has been processed for shipping, execution proceeds to step 506, where the shopper is informed that the order has already been processed. In step 508, the shopper is forwarded to a means to process a return. Returning to step 504, if the order has not yet processed for shipping, execution transitions to step 508, where a modification can be made. For example, the user can modify the quantity of the items ordered, the shipping address to where the order is to be shipped, the properties of the product, such as size, quantity, color, features, etc., or some other type of modification. In addition, the user can modify the order by applying a coupon, which may be in the form of a code that is entered. It should be noted that an order cancellation can be made by modifying the quantity ordered to zero. In step 512, the process is exited.

FIG. 5b is a flowchart depicting a process by which a return can be processed. In step 552 a request is received to return an item. In step 554, a return label is printed, and in step 556, instructions for the customer to return the item are printed. In step 558, a return record is created corresponding to the order with the status “return in process,” and in step 560, the process exits. The return will then be received and processed by a warehouse, and the customer's funds returned.

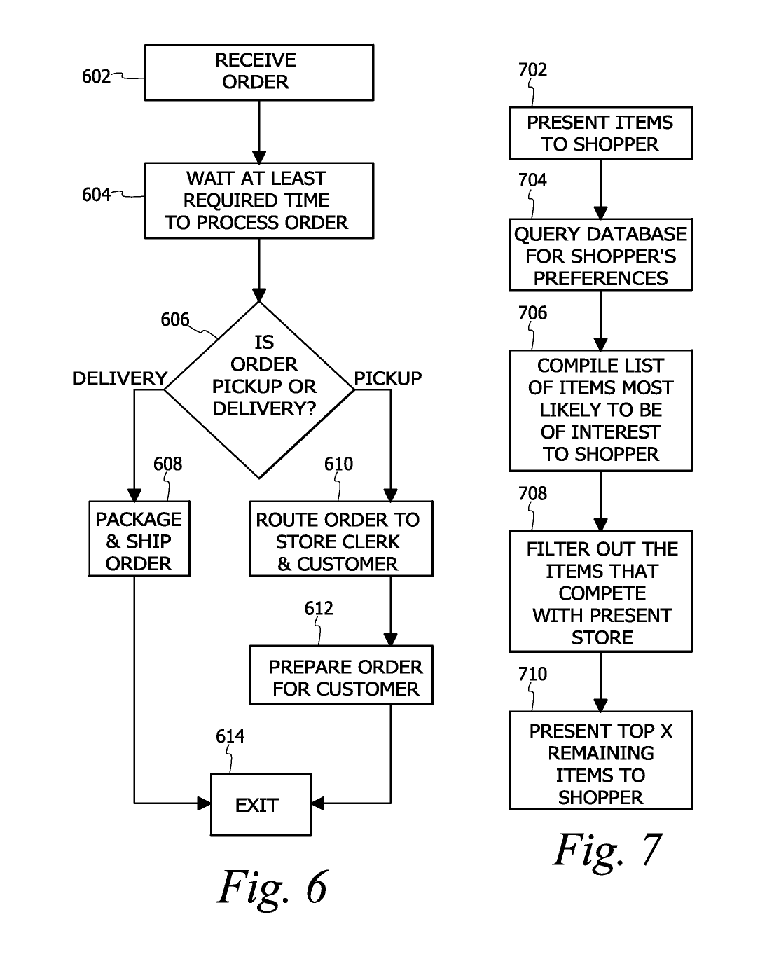

FIG. 6 is a flow chart depicting one process by which an order placed using the disclosed multi-tenant e-commerce system can be fulfilled. In step 602 an order is received by a shop. In step 604, a time period is marked off during which the shop is not permitted to process the order. This can be accomplished by not forwarding the order to the shop for the prescribed time, or, alternatively, through a business rule prohibiting the shop from changing the order status to “in process” for a prescribed period of time. This time period is required so that shoppers can make modifications or cancel an order shortly after ordering. In step 606, a determination is made as to whether the customer placed the order for delivery, or whether the customer intends to pick the order up. If the customer placed the order for delivery, in step 606 the order is packaged and shipped to the customer, and the process exits in step 614. However, if the customer placed the order for pickup, execution transitions to step 610 where the order is routed to the appropriate physical store closed to the customer's location. In step 612, the order is prepared for pickup by the customer by staff at the store, and the process exits in step 614. This process of order fulfillment allows customers to seamlessly cancel orders as well as to seamlessly return undesired goods.

An important feature of the disclosed multi-tenant e-commerce system is the function of presenting an item from a first shop to shoppers of a second non-competitive shop. This is generally accomplished by gathering a user's preferences, either directly from the shopper, or by monitoring the user's shopping habits. It should be noted that the disclosed e-commerce system encompasses both methods using any of the techniques known in the art.

FIG. 7 is a flow chart depicting one process by which items from one shop can be presented while a user is browsing a non-competitive shop. In step 702 items are presented to a shopper. In step 704, database 108 is queried for the shopper's preferences. Based on those preferences, a list of items most likely to be of interest to the shopper is compiled in step 706. In step 708, any items that would compete with offerings of the shop that the customer is presently browsing are filtered out. In step 710, the X items that are most likely to appeal to the customer are presented to the customer within the shop that s/he is browsing. Generally X should be a fairly small number, such as 1-3 items, although certain embodiments could present more items to a user.

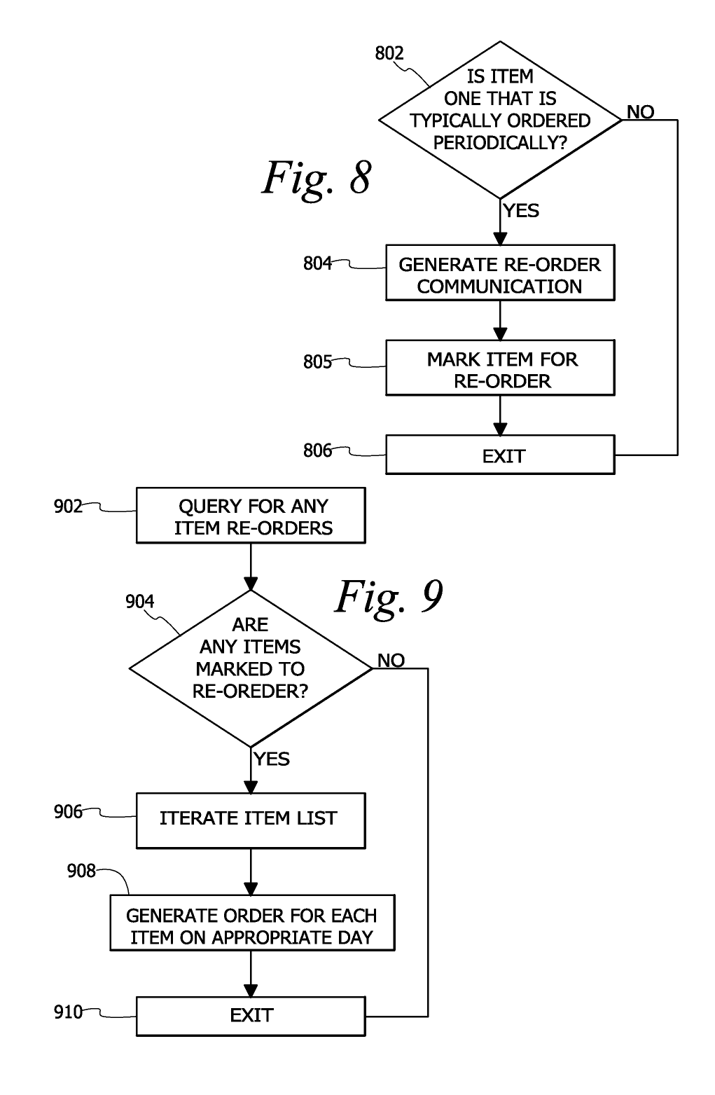

FIG. 8 depicts a flowchart describing one process by which certain items can be flagged for automatic reordering. In step 802, after an item is ordered a check is made to determine if it is one that is often ordered periodically. Items that are often ordered periodically include staple foods, such as rice, cleaning products, such as bleach, and personal care products, such as deodorant. In addition, other items may be flagged for reordering by a particular customer, or by the collective shopping patterns of all customers of the system. If the recently ordered item is not that is often ordered periodically, the process exits in step 806. However, if the recently ordered item is one that is often ordered periodically, execution transitions to step 804, where a communication to the shopper that ordered the item is generated and transmitted to the shopper, and in step 805, the item is marked for reordering on a standard schedule. The process then exits in step 806.

With regards to the communication generated in step 804, it can be for example, an email, a text message, or a robo-call, as indicated by the shopper's preferences (if a preference is set). In the communication, the user will be notified that a periodic order has been created, and given an option to modify the reorder period, or cancel it entirely. For example, an email can contain a hyperlink to a page allowing the user to set the reorder period or cancel the reorder entirely.

Turning to FIG. 9, a flowchart depicting one process by which periodic reorders can be automatically generated. The depicted process is to be run at a periodic interval, such as one time per day, and can be run for every shopper in the database. In step 902, a shopper's record is queried to determine if there are any item reorders. If there are not, the process exits in step 910. However, if there are item reorders, the list of reorder items is iterated in step 906, and, for each item reorder that should be ordered at the time the process is ran, a new order is generated and processed in step 908 as discussed earlier in this disclosure. The process then exits in step 910.

Another feature of one embodiment of the disclosed e-commerce solution is to allow lowest cost routing of orders by merchants (as well as by consumers as previously discussed). For example, it is well known that different payment processors charge different rates depending on various factors, such as the particular card that is presented. Accordingly, a merchant can configure the e-commerce system so that payments by, for example, Discover Card, are processed by a first processor, while American Express payments are processed by a second processor, and payments by Mastercard and Visa are processed by a third processor.

In addition, the system can periodically send communications, such as emails and SMS texts to shoppers that use the system. The communications can contain catalog listings of items that the shoppers are likely to be interested in based on the shopper's buying patterns, or that merchants are attempting to promote to certain classes of shoppers. In addition, the listings can contain indicia that allow the user to easily purchase the listed items. For example, an email or push notification can contain a button for each item listed in the communication; by pressing the button, the user can purchase the item with a single click as outlined herein. Similarly, an SMS communication can indicate a numeric code that the user replies with to purchase a particular item.

One issue that arises with conventional e-commerce solutions is that customers can abandon an order prior to completing it. This can lead to items being “orphaned” in the shopping cart. Items can be orphaned for a variety of reasons. First, the user can intentionally abandon the order. This would occur, for example, if the user did not want the items. Second, a user may experience a technical issue, such as a hardware or software crash, or a network issue, prior to completing the order. Or third, a user may have something more urgent arise, that distracts her attention from shopping prior to her completing the order. In cases two and three, both the user and the store are missing the benefit of completing the order.

In accordance with one embodiment, a communication, such as an email, SMS text, or push notification is generated and sent to a shopper after items are orphaned in a shopping cart for some period of time, such as, for example, four hours. The communication contains a listing of the items in the abandoned cart, and a “complete order” (or equivalent) device. By pressing the complete order (or equivalent) device, the order is completed, and the items in the cart are sent to the shopper.

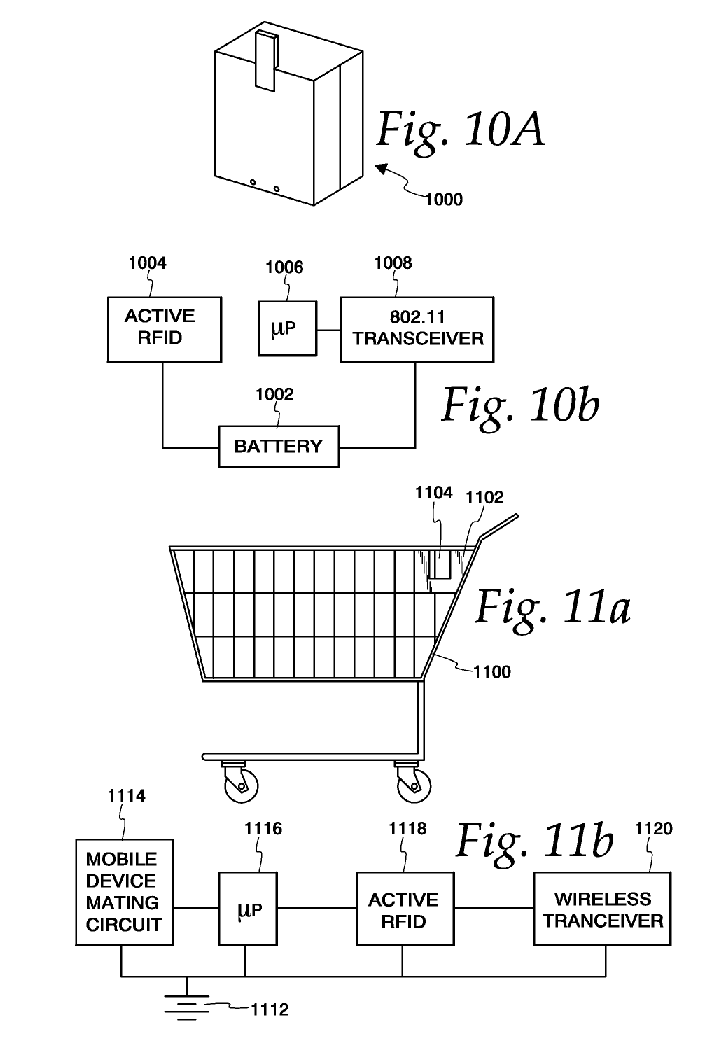

The disclosed e-commerce system also envisions improving on the traditional retail shopping experience by providing a novel new way to shop for goods. This embodiment is explained with reference to FIGS. 10a and 10b. In particular, the disclosed shopping system would allow customers of a retail store to purchase items simply by placing them in a specialized tote bag 1000. The tote bag 1000 contains a simple circuit woven into one of the interior walls or bottom comprising a battery, an active RFID device, and a wireless transceiver (such as an 802.11 transceiver). Each tote bag 1000 will need to be registered to a particular person who will need to have a preregistered payment means, such as a credit card or online wallet. To use this system, every item in the store must include a passive RFID, which, when brought in proximity to the active RFID of the tote bag 1000 signals a purchase by the tote bag's 1000 owner.

Turning to FIG. 10b, a simple block diagram of the tote bag circuit is disclosed. A battery 1002 powers an active RFID 1004. The active RFID 1004 can detect when a passive RFID coupled to a retail item (not shown) is brought into close proximity, such as when the item is placed in the tote. When this occurs, the active RFID 1004 signals the microprocessor 1006, which then causes the active RFID 1004 to read an identifier stored in the passive RFID corresponding to the item to which the passive RFID is attached. This identifier is then passed to the microprocessor 1006, which then uses the transceiver 1008 to transmit the item identifier to a store server (not shown) which completes the purchase on behalf of the user.

Given that the tote bag 1000 may come into contact with items that are within the store, but are not placed inside the tote bag 1000, there is a possibility that items could be spuriously purchased. One way to prevent this would be to shield the outside of the tote bag 1000 to prevent even a close coupling of the active RFID 1004 to a passive RFID (not shown) from activating the active RFID.

In another embodiment of the disclosed retail shopping service, consumers can utilize a mobile computing device to check out a shopping cart. Generally, consumers will register their mobile device with the shopping cart, which will operate similarly to the previously described tote bags 1000. Turning to FIGS. 11a and 11b, each shopping cart 1100 incorporates a circuit board 1102. In addition, in embodiments that are intended to mate with smart phones, a cradle 1104 can be provided.

The circuit 1102 can comprise a battery 1112, a mobile device mating circuit 1114, a microprocessor 1116, an active RFID, and a wireless transceiver 1120. The mobile device mating circuit 1114 can be a wired circuit, a wireless circuit, or both. For example, the mobile device mating circuit 1114 can be a wireless mating circuit, such as, for example, a Bluetooth wireless mating circuit. In such an embodiment, a customer would need to obtain an identifier (such as a number) from the shopping cart 1100, and input that into an application on the user's mobile computer device, which would then mate with the shopping cart 1100. The mobile device mating circuit 1114 can also be a wired circuit, such as, for example, a USB circuit. In such an embodiment, the user would physically mate a USB port on her device with a USB connector on the shopping cart 1100, which would activate an application on the user's mobile computing device allowing the user to confirm that the mating had occurred.

After the user's mobile computing device was mated with the mobile device mating circuit 1114, the microprocessor 1116 verifies that the user's mobile device contains a valid payment option. The active RFID 1118 and wireless transceiver operate similarly to the same devices in the tote bag embodiment.

In particular, in one embodiment, the active RFID 1118 can be mounted in a central position within the shopping cart 110. The active RFID 1118 detects when a passive RFID coupled to a retail item (not shown) is brought into close proximity; i.e., by the shopper moving it to within a few inches of the active RFID 1118. When this occurs, the active RFID 1118 signals the microprocessor 1116, which causes the active RFID 1118 to read an identifier stored in the passive RFID corresponding to the item to which the passive RFID is attached. This identifier is then passed to the microprocessor, which then uses the transceiver 1120 to transmit the item identifier to a store server (not shown) which completes the purchase.

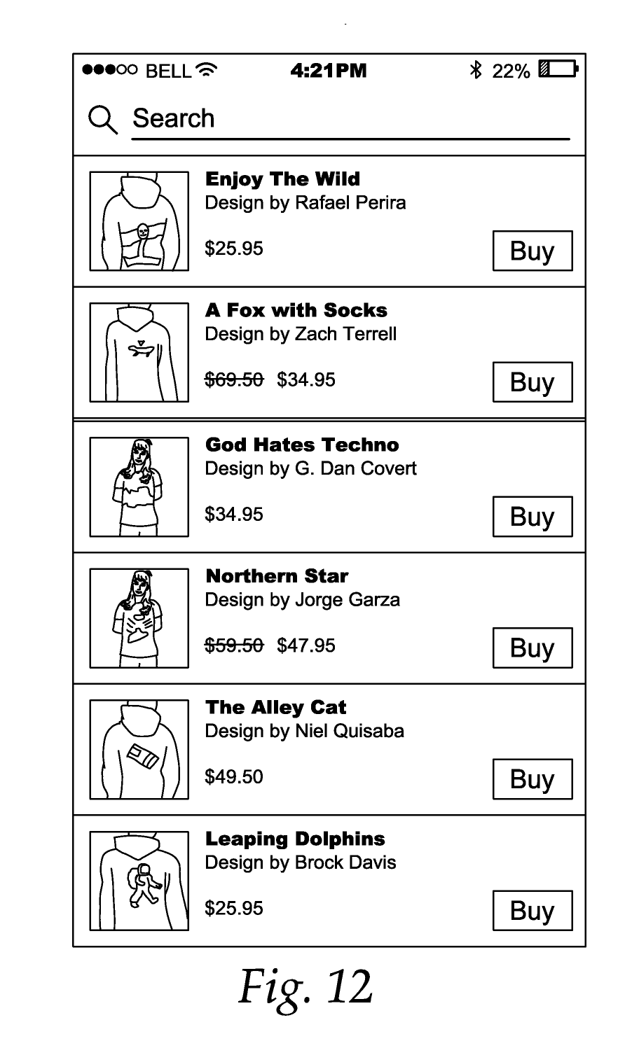

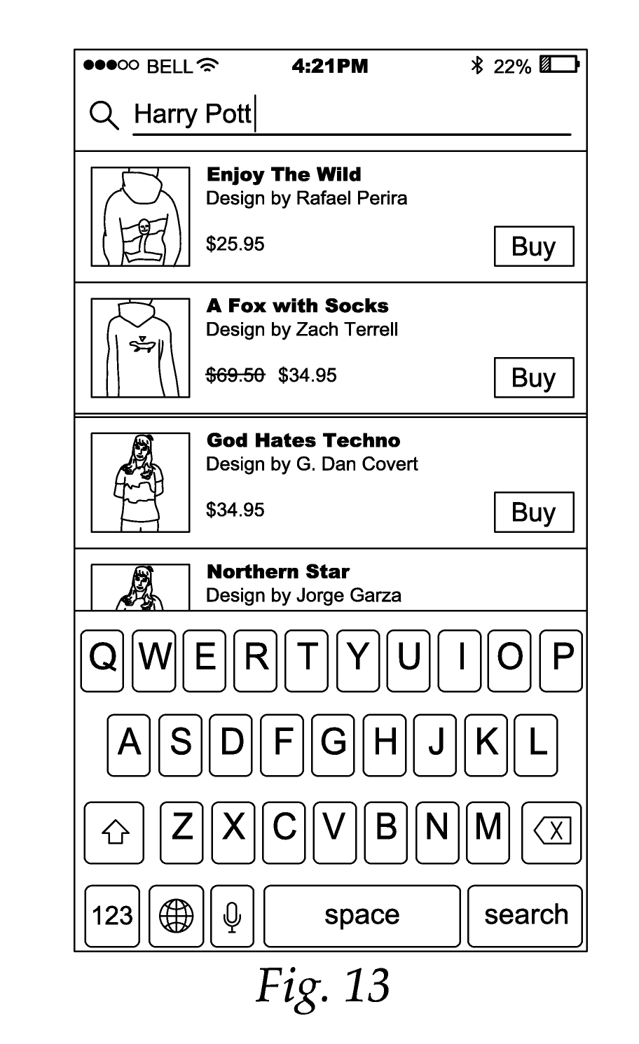

FIGS. 12 and 13 illustrate one embodiment of a smart phone application for use with the disclosed multi-tenant e-commerce system. Turning to FIG. 12, one embodiment of a view is depicted that a shopper that has already registered with the e-commerce system could see on first entering the application. The view depicted is customized to the shopper, and does not depict the listings on any particular store. Rather, based on the preferences of the user as determined by information submitted by the user or by monitoring the user's activities, products of many different shops can be displayed. FIG. 13 depicts a search by a shopper. In this embodiment, discovery of items is driven by the user's preferences and by searches conducted for specific items. As depicted, a standard soft keypad is used to enter a search term.

A completed electronic transaction, such as an online transaction or a transaction completed via an application on a mobile device, is typically not able to be modified or cancelled without assistance from customer service. For example, if a consumer buys a shirt and accidentally picks the wrong size, the user usually has to cancel the transaction and start again, if such an option is allowed by the retailer's electronic system, or the user has to contact customer service to have the size changed. As another example, if a consumer uses a personal credit instead of a work credit card on an electronic order of goods for the consumer's workplace, the consumer typically cannot change the payment method without having to cancel the original transaction and completely redo the transaction with the new payment method (e.g., work credit card).

As a further example, once the consumer has finalized and placed an electronic order, it is typically complicated or difficult to cancel the order and the cancellation may have to be done on the seller's (e.g., retailer) side through the assistance of customer service. As yet another example, once an electronic purchase is made, it is generally complicated and frustrating, or impossible without cancelling the original transaction, to apply a coupon to the transaction. Users are typically required to call customer service or visit a physical store to attempt to apply a coupon after purchase and before fulfillment. It is desirable to be able to provide a way for users to modify or undo a purchase for a period of time after the transaction has been completed, but before the order has been fulfilled (e.g., shipped).

The disclosed subject technology describes systems and techniques for providing modifications or cancellation of electronic orders (e.g., ecommerce, online orders, mobile applications). For example, a user (e.g., consumer) may complete a purchase of a product on a retailer's online store, mobile application, or website, but then wish to change something about or some aspect of the order afterwards. A post transaction order modification system is provided to allow a user to easily and quickly modify or cancel the completed electronic order after the order has been placed and before the order has been fulfilled.

The post transaction order modification system may provide a preset period of time after placement of an electronic order for allowing modification or cancellation of the order. The period of time may be set by the retailer, such as one hour, for example, during which the order is not finalized and sent to fulfillment on the retailer's side. The period of time is preferably identified to the consumer following entry of the order. Thus, the consumer may place an order and it appears to be finalized, but the order is held by the retailer for the preset time period to allow the consumer to make modifications or cancel the order electronic without the consumer having to contact customer service.

The consumer may also be allowed to change or modify a variety of different elements of an electronic order that has already been placed by the consumer. For example, the post transaction order modification system may provide an interface allowing the user to select a modification button or icon, i.e., a modification selector, to modify a previously completed order to change any of a variety of aspects about the transaction, including, but not limited to: shipping address, shipping method, an item or product variant (e.g., color, size, quantity), payment method, gift options (e.g., marked as a gift, edit note to recipient of gift, gift wrapping), to change or add additional services related to the item or product (e.g., monogramming, framing, gift box), or to apply a coupon. The interface may be part of the seller's electronic purchasing interface, so that the user may directly interact with the same website or electronic purchasing screen that the user used to place the original order. Thus, the post transaction order modification system may provide a seamless, self-serve method for users to modify aspects of their electronic orders without the need to contact the retailer for assistance or authorization.

Similarly, the post transaction order modification system also provides a method for the user to undo or cancel a previously place order without having to contact the retailer for assistance or authorization. Here, the placed order may be held by the retailer's system for a preset period of time before being sent to be fulfilled. This preset time may be the same as the preset time for making order modifications or it may be a different time period. For example, once an order is placed and sent to fulfillment, the retailer's system typically puts an inventory hold on the purchased items and creates an authorization or pre-authorization for the transaction, each of which has to be cancelled or reversed if the order is subsequently cancelled. Thus, if the user cancels the order during the preset period of time after the order has been placed, the post transaction order modification system may provide a simple cancellation of the order without requiring any inventory releases or authorization cancellations. Also, the post transaction order modification system may let the user cancel the previously placed order with one button or click, without the need for the user to contact the retailer for assistance or authorization to cancel the order.

The post transaction order modification system may also provide an inventory hold or an authorization/pre-authorization at the time the order is placed, yet still provide a preset period of time for holding the placed order prior to sending it to fulfillment or having the order fulfilled. Here, if the user cancels (e.g., unbuys) the order through the post transaction order modification system interface, the system may release the inventory hold and cancel the authorization/pre-authorization without fulfilling the order or without sending the order to fulfillment. In addition, the post transaction order modification system may provide a defined unbought transaction, which may be displayed to the user on the interface. Thus, the user can see that the previous purchase has been cancelled or unbought, and the user may easily rebuy the item if the cancellation was not intended or the user changes his or her mind.

Applying a coupon to the transaction after the purchase transaction has been completed (e.g., after the fact coupon) may also be provided by the post transaction order modification system. For example, a user may forget to apply a coupon the user already has when the user completes the purchase transaction, or the user may find a relevant coupon shortly after the purchase transaction is completed. This may cause the user to experience buyer's remorse and subsequently cancel the order. In addition, the retailer or merchant may be unable to track attribution and marketing potential of coupons if the coupon is not applied to the transaction.

Accordingly, the post transaction order modification system may provide an interface that allows the user to apply a coupon, such as with a coupon code, to the purchase transaction after the purchase transaction is completed. For example, a coupon may be passed along through a unified record locator (URL) that is then included in the transaction. As another example, a coupon may be automatically calculated and applied to the transaction by the system based on purchase history of the user (e.g., buy three, get one free; buy $50 or more and get free shipping). As yet another example, a coupon may be applied to an account and automatically applied as a user's purchases fulfill the requirements for the coupon.

Regardless of the method of coupon application to already completed purchase transactions, the post transaction order modification system allows the user to be self-reliant in applying coupon codes without having to involve customer service or having to go to a physical retail location. This benefits the retailer or seller in that the seller's customer service load is lessened. Additionally, the user does not have to cancel or return the entire order and then repurchase the order so that the coupon can then be applied. Also, the user is less likely to cancel the purchase transaction and may derive more satisfaction from the transaction, which may lead to positive publicity from the user for the seller (e.g., word of mouth, online reviews, user's blog or social network page).

The post transaction order modification application may be provided on any suitable computing device, such as a server, a personal computer, a tablet computer, a smartphone and the like. The post transaction order modification application may be linked to one or more electronic sales systems, such as electronic commerce systems, application, websites, and the like. A user may be required to onboard or sign up prior to making or completing a purchase. In one embodiment, the system or application determines if the user information entered by the user or otherwise obtained during the onboarding process (i.e., billing address, billing credit card, etc.) is valid. The user may then browse through a sales website, online product catalog or mobile retail application to identify and purchase products or services, for example. After the purchase transaction is complete, then the user may utilize the features of the post transaction order modification system.

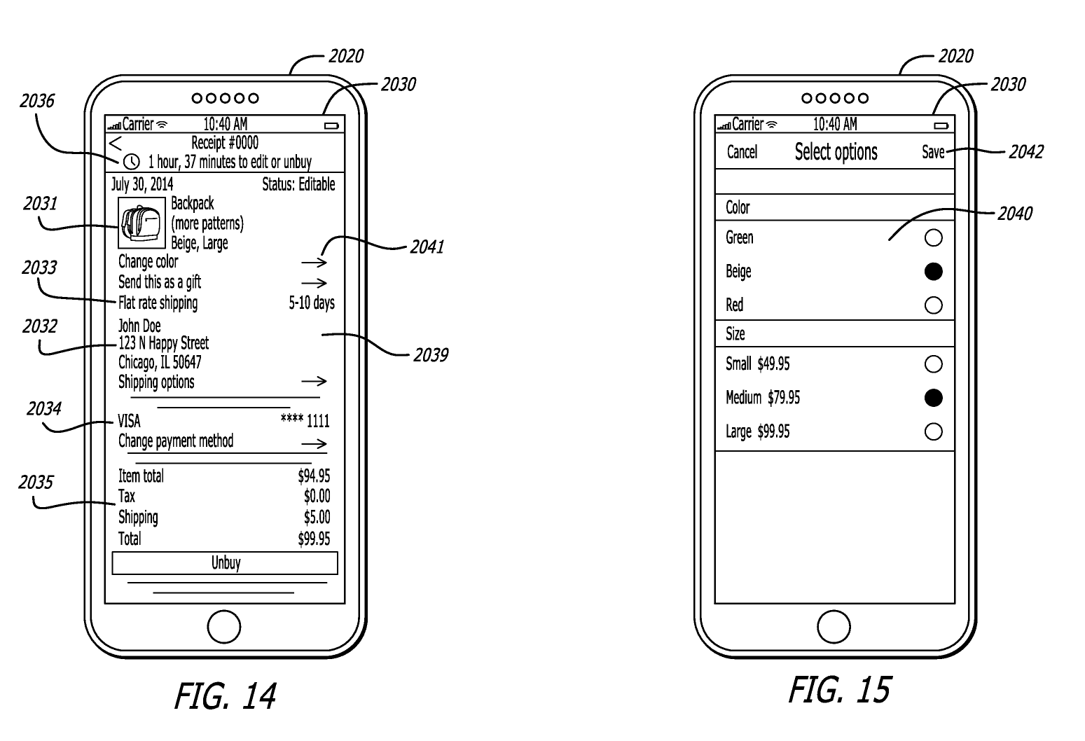

For example, as shown in FIG. 14, in one embodiment the user may have an online post transaction order modification user interface 2030 displayed on the user's device, which in one example is a mobile device 2020 (e.g., smartphone) that shows the details of a recently completed online purchase transaction 39, such as the product purchased 2031, the shipping address 2032 (e.g., the address to ship the product to), the selected shipping method 2033, the payment method 2034 and a receipt 2035. The illustrated post transaction order modification user interface 2030 also shows the remaining time 2036 left to modify or cancel the completed transaction at the top of the user interface window. The post transaction order modification user interface 2030 of FIG. 14, as well as other interfaces of the post transaction order modification system has a variety of types of change selectors, which may include buttons, icons, etc., that are selectable by the user. The explanation of various examples herein may only identify one type of change selector, however, any type of change selector may be provided and the scope of this disclosure is not limited to any specific type of change selector. In this example, the item purchased 2031 is a Backpack having a color Beige and being a size Large, as shown in FIG. 14. If the user selects one of the change selectors 2041 in interface 2030, in one embodiment, the system transitions to the product option screen of FIG. 15.

In FIG. 15, a product option screen 2040 is provided after the user selects a change selector 2041 that is a product option selector 2041, such as product option button 2041 or icon 2041, provided in the post transaction order modification user interface 2030 of FIG. 14 to change the color/size of the product. In the product option screen 2040 of FIG. 15, the user changes the size to Medium, which lowers the price by $20.00 as well.

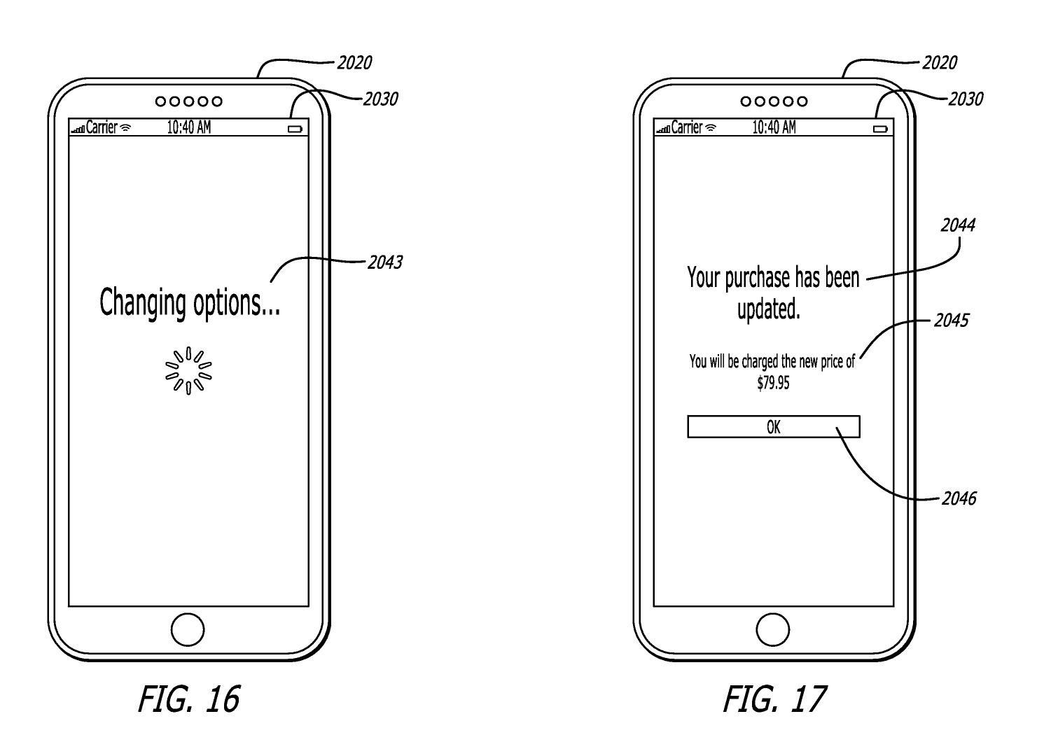

Once the new options (i.e., changing the size to Medium) are saved by selecting the save button 2042 in the product option screen 2040 of FIG. 15, in one embodiment the user interface transitions to the screen shown in FIG. 16 to provide an indication 2043 that the system is processing the change of options. In FIG. 17, a user interface 2030 is shown to provide confirmation 2044 that the previously completed purchase transaction has been updated. The confirmation display user interface 2030 of FIG. 17 also provides additional details 2045, which in this example includes the new price total for the order. The confirmation display may also provide an OK button 2046 so that the user can confirm that the new options are what the user wants.

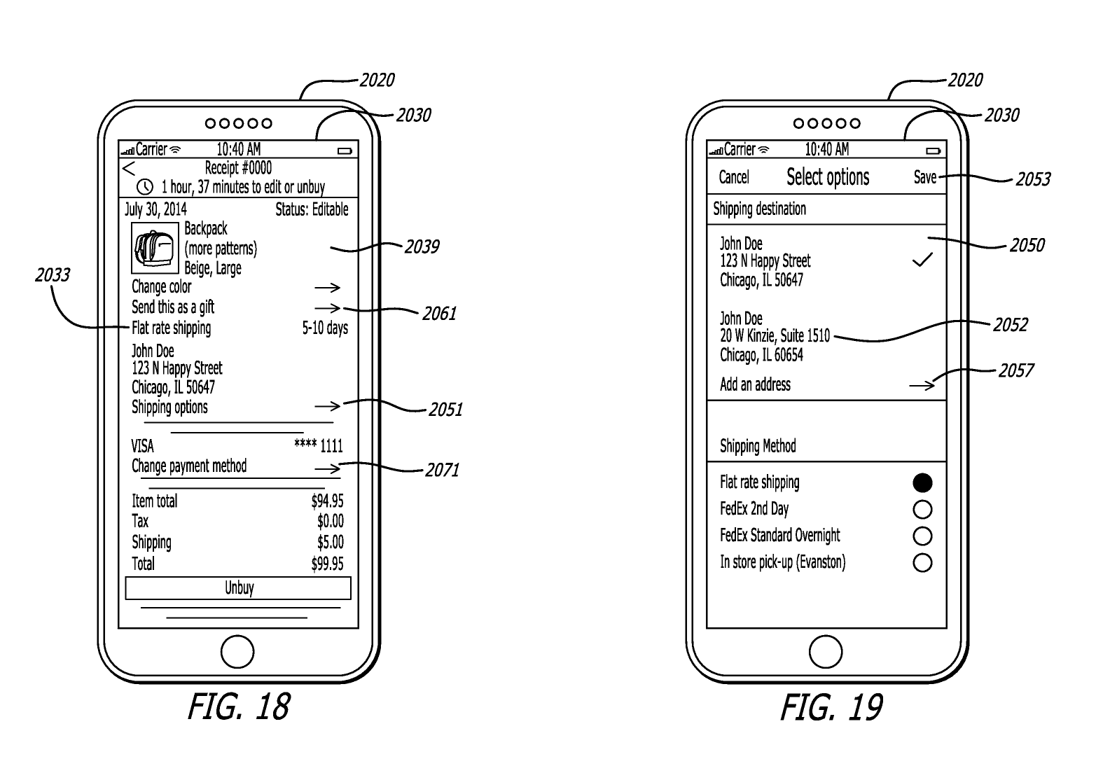

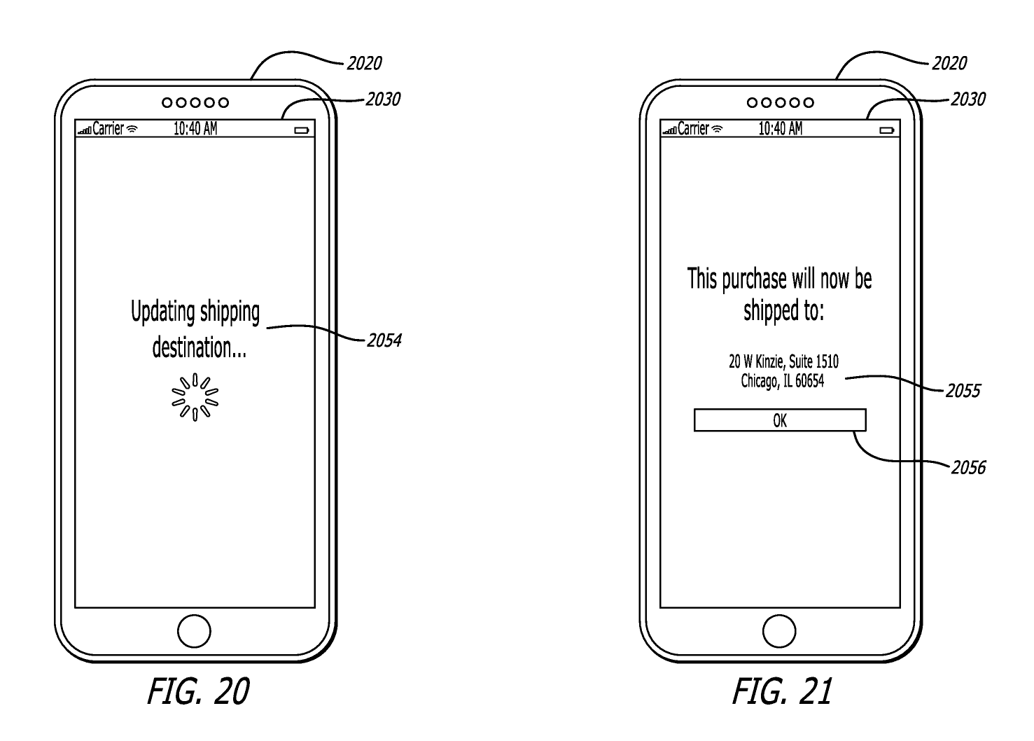

As shown in FIGS. 18-21, in one example through the post transaction order modification user interface 2030, a user may elect to change the shipping address after the purchase transaction has been completed. Here, in one embodiment, the user starts from a display or interface 2030 that shows the details of the recently completed purchase transaction 2039 (see FIG. 18). In this embodiment, the user selects a shipping options change selector 2051, such as icon 2051 or button 2051, to reach a shipping options screen 2050 (e.g., user interface) of the post transaction order modification system as shown in FIG. 19. The user then selects a different shipping address from a list of addresses 2052 or enters a new shipping address by selecting the new shipping address selector 2057 and entering the requested information. After the desired shipping address has been selected, the user selects the Save button 2053, and in FIG. 20 the user interface 2030 shows that the shipping destination is being updated 2054.

Then, in the display shown in FIG. 21, the interface displays the updated information 2055. An OK button 2056 is provided in the interface of FIG. 21 to confirm that the user wishes to keep the updated shipping address for the specific purchase transaction. Similar steps or user interface screens may be provided to change other options, such as gift options, payment methods, etc., by selecting various change selectors or buttons on the post transaction order modification user interface 2030. For example, on the post transaction order modification user interface 2030 there may be included a gift selector 2061 to change gift options, payment methods may be changed by selecting a Change payment method selector 2071, and coupon application modifications (not shown) may be provided for or modified for the previously completed purchase transaction.

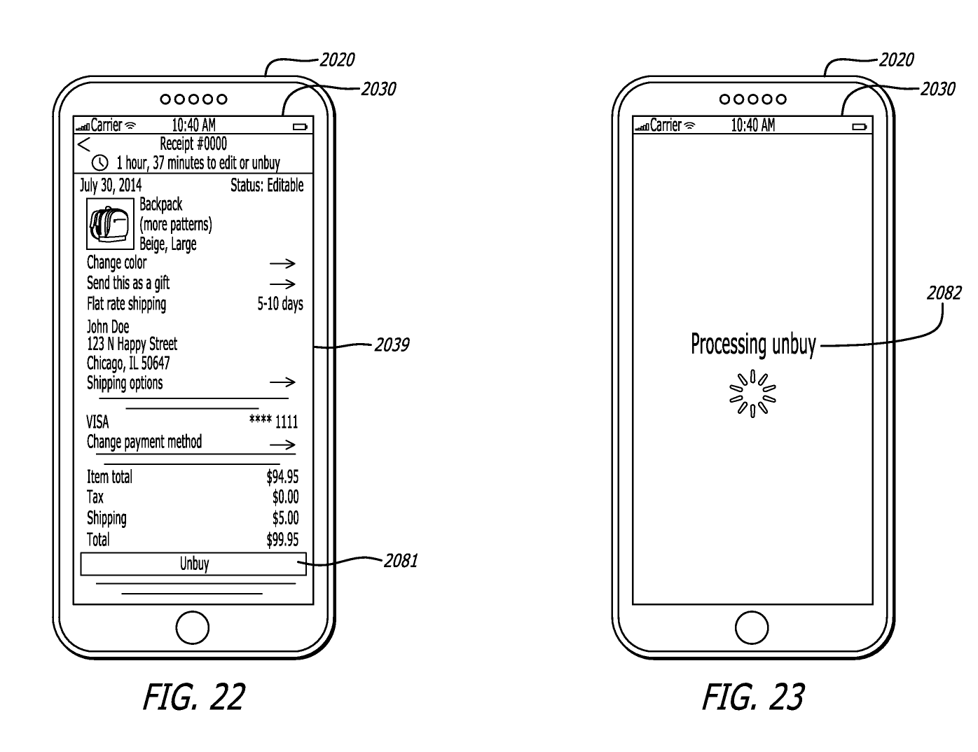

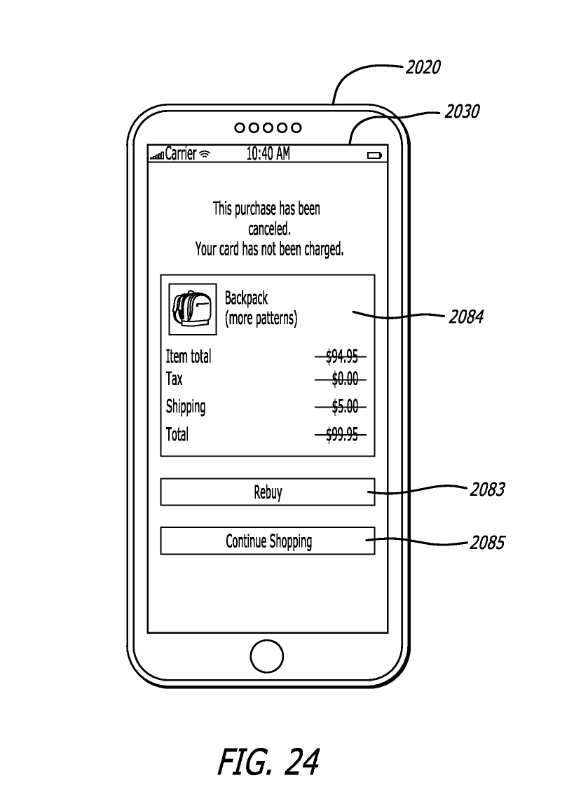

As shown in the user interfaces of FIGS. 22-24, in one embodiment, the user can also elect to cancel the purchase transaction (e.g., unbuy the product). In one embodiment, the display that shows the details of the recently completed purchase transaction 2039, which in this example is shown in FIG. 22, includes an unbuy selector 2081 at the bottom that allows the user to unbuy the already purchased product with one click or selection of the unbuy selector 2081. In FIG. 23, after the unbuy selector 2081 is selected, the user interface 2030 provides an indication that the transaction is being unbought 2082. In FIG. 24, the user interface 2030 includes a Rebuy button 2083 allowing the user to rebuy the product with a single click. The user interface 2030 in FIG. 24 also provides an updated receipt 2084 showing the removal of the purchased item(s) and a Continue Shopping button 2085 that directs the user to a display of a shopping page or website when selected. For example, the user may continue shopping within the seller's site or on the seller's application after the unbuy process has been completed by selecting the Continue Shopping button 2085.

In various embodiments, as explained above, the system allows for unbuying and/or modifying previously processed orders. Additionally, the system may also allow in certain embodiments for various promotions or benefits to the user post processing, including, but not limited to, the batching of certain orders for shipping, and promotions based on spend thresholds.

In one embodiment, immediately upon the user selecting to “buy” a product, the system processes the order. Once the order is processed, in one embodiment an electronic receipt or confirmation is provided to the user, signifying that the order is completed, and the system locks the order. Additionally, at that time the system may create one or more different thresholds, including but not limited to an (1) edit time value, a (2) batch duration time, which is also referred to as the order cutoff time; and (3) free shipping qualification based on certain thresholds. In one embodiment, the edit time value is a period of time set by the retailer/seller within which the user may modify or unbuy their order following the completion of the order. Typically, the edit time is configured by the retailer/seller as part of their system configuration. For example, if the seller sets the edit time at 2 hours, when a buyer makes a purchase at 4:15, the buyer has until 6:15 to either unbuy or modify that order. After 6:15, in this example, the order is marked as unchangeable and the buyer/user can no longer make changes through the system to that order.

Similarly, in one embodiment, a batch relates to orders that are designated to be shipped to the same address and which are placed within a certain window of time, or before a certain deadline, both of which are defined by the seller/retailer, so that they can be passed to fulfillment together. Doing so helps the user/buyer not have to repeatedly pay separate shipping for items purchased within a buying session, and it also allows for logistical efficiencies for the retailer. Like the edit time value, the batch duration time is a period of time set by the retailer/seller within which all orders by a user that are designated to be shipped to the same address can be shipped together. Alternately, the batch duration time may be a deadline whereby all orders by a user that are designated to be shipped to the same address can be shipped together. For example, if the batch duration time is set at 3 hours, and the buyer makes a purchase at 4:15, all subsequent orders of the buyer that are designated to be shipped to the same address and which are completed prior to 7:15 will be batched together and the buyer will typically receive a reduced shipping rate for all batched purchases. As an alternate example, the seller/retailer may set a given time of day, such as 5:00 pm, as a batch deadline, whereby all orders made from the prior day at 5:01 pm until the present day at 5:00 pm, and which are designated to be shipped to the same address, will be batched together for shipment purposes. In such an embodiment, the batch would contain all completed purchases for the same address into a shipment so that it can be passed to the fulfillment system for processing at the same time every day, which in this example is 5:00 pm. Once a user buys an item, the system reminds the buyer about the time they have left to add to their order for reduced or no additional shipping cost.

Further, in one embodiment the system allows the retailer/seller to offer free shipping to the user based on certain requirements, such as attaining a threshold for dollars spent or items purchased in a session. For example, in one embodiment, the system will prompt the user after their make their first purchase about the additional money they need to spend, i.e. the ‘spend threshold’, within a time threshold determined by the retailer, to qualify for free shipping. Once the user hits the spend threshold within the time threshold, the shipping costs the user was charged when purchasing their prior item(s) will be reversed. Similarly, once a user buys an item, the system reminds the buyer about the time they have left to add to their order for reduced or no additional shipping cost.

In various embodiments, the system provides indicators on the various displays viewed by the user, e.g., website pages or application screens, of the time needed to qualify additional purchases for reduced shipping, the time/amount needed to qualify additional or all purchases for free shipping, or the time allowed and/or remaining for unbuying or editing an order.

Below are two examples of buying scenarios under the disclosed system:

### EXAMPLE 1

Retailer threshold configuration: Edit time is 2 hours, free shipping qualification is $50, and batch duration time is 3 hours.

Buyer X logs into the system, an application on her smartphone, to make purchases. At 2:45 pm, Buyer X views Wrinkle Cream and is shown a price of $29.99, which is inclusive of shipping and tax. Buyer X selects “buy.” The system knows: (1) Buyer X has 2 hours to change anything about this order, (2) if Buyer X spends $50 total in over two hours she will qualify for free shipping, and (3) anything Buyer X orders in the next 3 hours could go in the same box, and she can receive reduced shipping costs.

At 2:47 pm, after her first purchase, Buyer X views a new product list. The footer on the screen states “spend $20.01 more by 5:45 to get free shipping on your Wrinkle Cream.” As identified, the system will calculate the difference in spend that will allow the user to earn free shipping.

At 2:53 pm, Buyer X buys an Insulated Family Cooler in Cali Stripes. Buyer X is charged the price of the item as well as tax. Buyer X is NOT charged for shipping because she has hit the threshold for $50 within the two hour window.

At 3:43 pm, Buyer X changes her mind about the Insulated Family Cooler and modifies it to the Emma Pink version since she is within the 2 hour edit time window.

At 4:45 pm, the initial order is marked as unchangeable and batching countdown starts. At 4:53 pm, the second order is marked as unchangeable and another batching countdown starts. Buyer X then sets her smartphone down for a while.

At 5:40 pm, Buyer X turns her smartphone back on and gets back into the application. The footer on the home view states “FREE SHIPPING ON ALL ORDERS PLACED UNTIL 5:45 pm.” At 5:44 pm, Buyer X buys Bug Spray. Buyer X is charged the price of the item as well as tax. Buyer X is NOT charged for shipping because she is still inside of the batching window of her first purchase.

At 5:46 pm, Buyer X views the ‘home’ product list on the application. All prices are now inclusive of the cost of shipping and the footer now shows “PRICES INCLUDE TAXES AND SHIPPING”. At 5:47 pm, Buyer X buys a Wine Glass, and is charged the price of the item as well as the price of shipping and tax. The system knows: (1) Buyer X has 2 hours to change anything about this order, (2) if she spends $50 total in over two hours, she will qualify for free shipping, (3) anything she orders in the next 3 hours could go in the same box, and we can save the user on shipping costs.

At 7:44 pm, the third order is marked as unchangeable and another batching countdown starts.

At 7:45 pm, the first order batching countdown ends. The system checks for all of the orders that are unchangeable that could be batched together; it finds the first, second and third orders and puts them together into a shipment. That shipment is sent to the identified shipping address. The process will also invalidate the countdowns associated with any of the items in the shipment.

### EXAMPLE 2

Retailer threshold configuration: Edit time to 2 hours, and order cutoff time is 5 pm.

Buyer X logs into the system, an application on her smartphone, to make purchases. At 2:45 pm, Buyer X views Wrinkle Cream and is shown a price of $29.99, which is inclusive of shipping and tax. Buyer X selects “buy.” The system knows: (1) Buyer X has 2 hours to change anything about this order, (2) anything Buyer X orders until 5 pm could go in the same box, and she can save shipping costs.

At 2:47 pm, after her first purchase, Buyer X views a new product list. The footer on the screen states “REDUCED SHIPPING COSTS ON ALL ORDERS PLACED UNTIL 5:00 pm.”

At 2:53 pm, Buyer X buys an Insulated Family Cooler in Cali Stripes. Buyer X is charged the price of the item, tax, as well as the incremental cost of shipping. She is ONLY charged for the incremental cost of shipping because she has made the second order before the batching cutoff time (5 pm) of the day.

At 3:43 pm, Buyer X changes her mind about the Insulated Family Cooler and modifies it to the Emma Pink version since she is within the 2 hour edit time window.

At 4:45 pm, the initial order is marked as unchangeable and batching countdown starts. At 4:53 pm, the second order is marked as unchangeable and another batching countdown starts. Buyer X then sets her smartphone down for a while.

At 4:56 pm, Buyer X turns her smartphone back on and gets back into the application. The footer on the home view states “REDUCED SHIPPING COSTS ON ALL ORDERS PLACED UNTIL 5:00 pm.” At 4:57 pm, Buyer X buys Bug Spray. Buyer X is charged the price of the item, tax, as well as the incremental cost of shipping. She is ONLY charged for the incremental cost of shipping because she is before the batching cutoff time (5 pm) of the day.

At 5:06 pm, Buyer X views the ‘home’ product list on the application. All of the prices are now inclusive of the cost of shipping, the footer now shows “PRICES INCLUDE TAXES AND SHIPPING”. At 5:47 pm, Buyer X buys a Wine Glass, and is charged the price of the item as well as the price of shipping and tax. The system knows: (1) Buyer X has 2 hours to change anything about this order, (2) anything she orders in the next ˜23 hours (until 5 pm the following day) could go in the same box, and we can save the user on shipping costs.

At 6:56 pm, the third order is marked as unchangeable.

At 7:00 pm, the daily order batching cutoff occurs. This occurs a full edit time after the configured order cutoff time. The system checks for all of the orders that are unchangeable that could be batched together; it finds the first three orders and puts them into a shipment. That shipment is sent to fulfillment.

At 7:47 pm, the fourth order is marked as unchangeable.

At 7:00 pm (next day), order batching cutoff occurs. The system checks for all of the orders that are unchangeable that could be batched together; it finds the forth order only, and puts it into a shipment. That shipment is sent to fulfillment.

Days later Buyer X receives two shipments, staggered by a day. The first containing her first three orders, the second (which arrive a day later) containing her fourth.

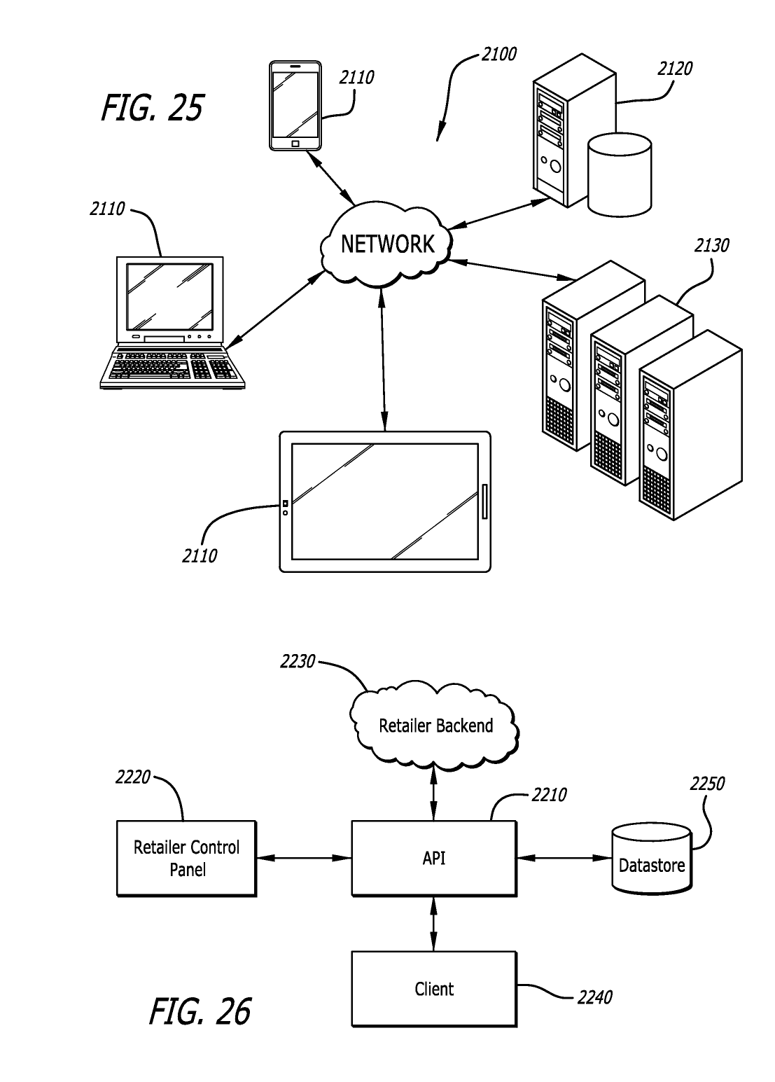

As shown in FIG. 25, the post transaction order modification application may be provided on a client-server system 2100. For example, the post transaction order modification application may be provided on a user's electronic device 2110, where the post transaction order modification application connects to sales websites or online stores through the server 2120 of a seller or retailer. A separate server 2130 based website may also be provided. The separate server 2130 based website may be configured to provide the same post transaction order modification application features to registered users as the device based post transaction order modification application. For example, a post transaction order modification application user may log in directly to the post transaction order modification application website and select changes to a recently completed purchase transaction. This allows the user to access the post transaction order modification application if the user's device 2110 is not functioning, such as if the user's smartphone battery died, for example.

As shown in FIG. 26, the post transaction order modification application may be an application program interface (API) 2210 that interacts with one or more systems involved in an electronic or online purchase transaction. For example, the API 2210 may interface with a retailer system through a Retailer Control Panel 2220 and through a Retailer backend system 2230. The API 2210 may also interface with the user through a Client device and/or application 2240. The API 2210 may further interface with one or more databases 2250, such as a Datastore database that may provide information regarding completed transactions.

As used in this specification and any claims of this application, the terms “computer,” “server,” “processor,” and “memory” all refer to electronic or other technological devices. These terms exclude people or groups of people. For the purposes of the specification, the terms display or displaying means displaying on an electronic device. As used in this specification and any claims of this application, the terms “computer-readable medium” and “computer-readable media” are entirely restricted to tangible, physical objects that store information in a form that is readable by a computer. These terms exclude any wireless signals, wired download signals, and any other transient signals.

To provide for interaction with a user, implementations of the subject technology described in this specification can be implemented on a computer system having a display device, e.g., a CRT (cathode ray tube), LCD (liquid crystal display), LED (light emitting diode), or DLP (digital light processing) monitor, for displaying information to the user and a keyboard and a pointing device, e.g., a mouse, a trackball, or a touchpad, by which the user can provide input to the computer system. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Aspects of the subject technology described in this specification can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject technology described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the aspects described above should not be understood as requiring such separation in all aspects, and it should be understood that the described program components and systems can generally be integrated together in a single system device or multiple devices.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology. Features described under one heading or one subheading of the subject disclosure may be combined, in various embodiments, with features described under other headings or subheadings. Further it is not necessarily the case that all features under a single heading or a single subheading are used together in embodiments.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A post transaction order modification system comprising:
one or more processors;
one or more storage memories;
a display; and, a post transaction order modification module comprising instructions for causing the one or more processors to execute a method for providing post transaction order modification of an electronic transaction, the method comprising:
providing, on the display, details of a recently completed electronic purchase transaction, the details comprising a listing of one or more products purchased;
providing, on the display, a time display showing how much time remains to modify or cancel the completed electronic purchase transaction;
providing, on the display, at least one of an unbuy selector and a change selector associated with recently completed electronic purchase transaction; and,
providing, by the one or more processors, for an immediate cancellation of the completed electronic purchase transaction when the unbuy selector is selected while there is still time remaining in the time display, and for an immediate change of the completed electronic purchase transaction when the change selector is selected while there is still time remaining in the time display.

2. The system of claim 1, further comprising:
providing, on the display, an indication the completed electronic purchase transaction is being cancelled when the unbuy selector is selected.

3. The system of claim 1, further comprising:
providing, on the display, a receipt showing the cancelled electronic purchase transaction.

4. The system of claim 3, further comprising:
providing, on the display, a rebuy selector; and,
providing for an immediate rebuy of the one or more products listed in the cancelled electronic purchase transaction upon selection of the rebuy selector.

5. The system of claim 3, further comprising:
providing, on the display, a continue shopping selector; and,
providing, on the display, an electronic shopping page upon selection of the continue shopping selector.

6. The system of claim 1, wherein the change selector is a product option selector, and further comprising:
providing, on the display, a product option user interface, the product option user interface comprising one or more product option selection selectors; and,
providing for modification of the completed electronic purchase transaction when one or more of the product option selection selectors are selected.

7. The system of claim 6, further comprising:
providing, on the product option user interface on the display, confirmation that the completed electronic purchase transaction has been updated; and,
providing, on the product option user interface on the display, a selector configured to confirm that the updated completed electronic purchase transaction is approved by the user when the selector is selected.

8. The system of claim 1, wherein the change selector is a shipping option selector, and further comprising:
providing, on the display, a shipping option user interface, the shipping option user interface comprising one or more product option selection selectors; and,
providing for modification of the completed electronic purchase transaction when one or more of the product option selection selectors are selected.

9. The system of claim 8, further comprising:
providing, on the shipping option user interface on the display, an add an address selector configured to provide one of a screen to receive a different shipping address from an inputted address and a selection of a different shipping address from a list of addresses; and,
providing for modification of the shipping address when the different shipping address is received or selected.

10. The system of claim 9, further comprising:
providing, on the product option user interface on the display, confirmation that the shipping address has been updated; and,
providing, on the shipping option user interface on the display, a selector configured to confirm that the updated shipping address is approved by the user when the selector is selected.

11. The system of claim 1, wherein the change selector is a change payment method selector, and further comprising:
providing, on the display, a payment option user interface, the payment option user interface comprising one or more payment option selection selectors; and,
providing for modification of the completed electronic purchase transaction when one or more of the payment option selection selectors are selected.

12. The system of claim 1, further comprising:
providing, on the display, a send this as a gift selector;
providing, on the display, a gift option user interface, the gift option user interface comprising one or more gift option selection selectors; and,
providing for modification of the completed electronic purchase transaction when one or more of the gift option selection selectors are selected.

13. The system of claim 1, further comprising:
providing, on the display, a coupon selector;
providing, on the display, a coupon option user interface, the coupon option user interface comprising one or more coupon option selection selectors; and,
providing for modification of the completed electronic purchase transaction when one or more of the coupon option selection selectors are selected.

14. A non-transitory machine-readable storage medium comprising machine readable instructions for causing a processor to execute a method for providing post transaction order modification of an electronic transaction, the method comprising:
providing, on the display, details of a recently completed online purchase transaction, the details comprising a listing of one or more products purchased;
providing, on the display, a time display showing how much time remains to modify or cancel the completed electronic purchase transaction;
providing, on the display, an unbuy selector associated with recently completed online purchase transaction; and,
providing, by the one or more processors, for an immediate cancellation of the completed online purchase transaction when the unbuy selector is selected while there is still time remaining in the time display.

15. The non-transitory machine-readable storage medium of claim 14, further comprising machine readable instructions for:
providing, on the display, a receipt showing the cancelled electronic purchase transaction;
providing, on the display, a rebuy selector;
providing for an immediate rebuy of the one or more products listed in the cancelled electronic purchase transaction upon selection of the rebuy selector;
providing, on the display, a continue shopping selector; and,
providing, on the display, an electronic shopping page upon selection of the continue shopping selector.

16. The non-transitory machine-readable storage medium of claim 14, further comprising machine readable instructions for:
providing, on the display, a product option selector;
providing, on the display, a product option user interface, the product option user interface comprising one or more product option selectors;
providing for modification of the completed electronic purchase transaction when one or more of the product option selectors are selected;
providing, on the product option user interface on the display, confirmation that the completed electronic purchase transaction has been updated; and,
providing, on the product option user interface on the display, an ok selector configured to confirm that the updated completed electronic purchase transaction is approved by the user when the ok selector is selected.

17. The non-transitory machine-readable storage medium of claim 14, further comprising machine readable instructions for:
providing, on the display, at least one of a shipping option selector, a change payment method selector, a send this as a gift selector and a coupon selector; and,
providing for modification of the completed electronic purchase transaction when one or more of the shipping option selector, the change payment method selector, the send this as a gift selector and the coupon selector are selected.

18. A post transaction order modification system comprising:
one or more processors;
one or more storage memories;
a display; and,
a post transaction order modification module comprising instructions for causing the one or more processors to execute a method for providing post transaction order modification of an electronic transaction, the method comprising:
providing, on the display, details of a recently completed electronic purchase transaction, the details comprising a listing of one or more products purchased;
providing, on the display, a time display showing how much time remains to modify or cancel the completed electronic purchase transaction;
providing, on the display, a product option selector associated with recently completed electronic purchase transaction; and,
providing, by the one or more processors, for an immediate change of the completed electronic purchase transaction when the product option selector is selected while there is still time remaining in the time display.

19. The post transaction order modification system of claim 18, further comprising:
providing, on the display, a product option user interface, the product option user interface comprising one or more product option selectors;
providing for modification of the completed electronic purchase transaction when one or more of the product option selectors are selected;
providing, on the product option user interface on the display, confirmation that the completed electronic purchase transaction has been updated;
providing, on the product option user interface on the display, an ok selector configured to confirm that the updated completed electronic purchase transaction is approved by the user when the ok selector is selected; and,
providing, by one or more processors, for completion of the modified electronic purchase transaction when the ok selector is selected.

20. The post transaction order modification system of claim 18, further comprising:
providing, on the display, an unbuy selector associated with recently completed electronic purchase transaction;
providing, by the one or more processors, for an immediate cancellation of the completed electronic purchase transaction when the unbuy selector is selected while there is still time remaining in the time display; and,
providing, on the display, an indication that the completed electronic purchase transaction is being cancelled when the unbuy selector is selected.
